(19) United States
(12) Patent Application Publication
(10) Pub. No.: US 2010/0131525 A1
(43) Pub. Date: May 27, 2010

(54) Integrated Systems and Methods of Web-Based Equestrian Data Management and Performance Metric Correlation

(75) Inventors: Michael J. Mahan, JR., Collinsville, TX (US); Tracy Lee Mahan, Collinsville, TX (US)

Correspondence Address: Klemchuk Kubasta LLP, 8150 N Central Expressway, SUITE 1150, DALLAS, TX, 75206, US

(73) Assignees: Michael J. Mahan, JR.; Tracy Lee Mahan; Track My Horse, LLC, A Texas Limited Liability Company, Collinsville, TX (US)

(21) Appl. No.: 12/275,207

(22) Filed: Nov. 21, 2008

(51) Int. Cl. G06F 17/30; G06F 3/00; G06F 7/00

(52) U.S. Cl. 707/758; 715/738; 707/E17.116

(57) ABSTRACT

The systems and methods of the present disclosure provide an authorized user with the ability to input and store past and current racing information and compare that information to a particular characteristic or set of characteristics to prepare reports, objective rating/performance systems, training regimens, value assessments and otherwise compare and analyze the data in real time for a variety of other reasons. The authorized user can access, create performance reports, and/or update data on the proposed system via the web using any device configured to access the Internet including, for example, any stand alone computer, networked device or suitable mobile device.

### BACKGROUND

Trainers, owners, investors, equestrian enthusiasts, casual observers, and the like typically use information about a particular horse in order to train, offer for sale, buy, invest, bet on, or otherwise participate in some kind of equestrian event. Conventional record-keeping systems and methods fail to provide an integrated data management and performance metric correlation system and method to easily track, monitor, record, correlate, predict, display, relate, or otherwise view, access, report, analyze, or share data, let alone provide correlation schemes between such data and other relevant performance metrics.

### SUMMARY

Embodiments of the present disclosure could generally provide a web-based integrated data management and performance metric correlation system and method to easily track, monitor, record, correlate, predict, display, relate, or otherwise view, access, report, analyze, or share data and correlate such data with other relevant performance metrics.

In one embodiment, the present disclosure could generally provide an integrated system of managing and correlating equestrian related information. The system could include a logbook to store the equestrian related information. The system could also include an analyzer to correlate the equestrian related information according to a user request. The system could further include a graphical user interface (GUI) accessible by the Internet to display the correlated data.

In one embodiment, the present disclosure could generally provide a method of managing and correlating equestrian related data. The method could include storing equestrian information in an Internet accessible logbook. The method could also include storing competitive race information related to the horse. The method could further include correlating the equestrian information and the competitive race information. The method could further include displaying the correlated information using a graphical user interface (GUI).

In one embodiment, the present disclosure could generally provide an integrated system of managing and correlating equestrian related data over the Internet. The system could include a logbook to store competitive race information and the equestrian related data related to a horse. The equestrian related data could include at least one of: biological information, medical information, farrier information, tack information, nutritional information, and genealogical information. The system could also include an analyzer to correlate the competitive race information with the equestrian related data. The system could further include a graphical user interface (GUI) accessible by the Internet to display the correlated data.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a somewhat simplified diagram illustrating an exemplary integrated web-based equestrian data management and performance metric correlation system according to one embodiment of the present disclosure;

FIG. 2 is an exemplary illustration of a graphical user interface (GUI) of a home webpage of the system shown in FIG. 1 according to one embodiment of the present disclosure;

FIG. 3 is an exemplary illustration of a GUI of a log-in webpage of the system shown in FIG. 1 according to one embodiment of the present disclosure;

FIG. 4A is an exemplary illustration of a GUI of a webpage of the system shown in FIG. 1 displaying overall statistics for all of a member's horses according to one embodiment of the present disclosure;

FIG. 4B is an exemplary illustration of a GUI of a webpage of the system shown in FIG. 1 displaying overall statistics for a selected one of a member's horses according to one embodiment of the present disclosure;

FIG. 5A is an exemplary illustration of a GUI of a webpage of the system shown in FIG. 1 displaying farrier information about a selected horse according to one embodiment of the present disclosure;

FIG. 5B is an exemplary illustration of a GUI of a webpage of the system shown in FIG. 1 displaying expanded farrier information about a selected horse according to one embodiment of the present disclosure;

FIG. 5C is an exemplary illustration of a GUI of a webpage of the system shown in FIG. 1 displaying genealogy related information about a selected horse according to one embodiment of the present disclosure;

FIG. 5D is an exemplary illustration of a GUI of a webpage of the system shown in FIG. 1 displaying general information about a selected horse according to one embodiment of the present disclosure;

FIG. 5E is an exemplary illustration of a GUI of a webpage of the system shown in FIG. 1 displaying medical related information about a selected horse according to one embodiment of the present disclosure;

FIG. 5F is an exemplary illustration of a GUI of a webpage of the system shown in FIG. 1 displaying expanded medical related information about a selected horse according to one embodiment of the present disclosure;

FIG. 5G is an exemplary illustration of a GUI of a webpage of the system shown in FIG. 1 displaying expanded medical related information having an automatic population feature about a selected horse according to one embodiment of the present disclosure;

FIG. 5H is an exemplary illustration of a GUI of a webpage of the system shown in FIG. 1 displaying professional network related information about a selected horse according to one embodiment of the present disclosure;

FIG. 5I is an exemplary illustration of a GUI of a webpage of the system shown in FIG. 1 displaying supplement related information about a selected horse according to one embodiment of the present disclosure;

FIG. 5J is an exemplary illustration of a GUI of a webpage of the system shown in FIG. 1 displaying expanded supplement related information about a selected horse according to one embodiment of the present disclosure;

FIG. 5K is an exemplary illustration of a GUI of a webpage of the system shown in FIG. 1 displaying tack related information about a selected horse according to one embodiment of the present disclosure;

FIG. 5L is an exemplary illustration of a GUI of a webpage of the system shown in FIG. 1 displaying expanded tack related information about a selected horse according to one embodiment of the present disclosure;

FIG. 6 is an exemplary illustration of a GUI of a webpage of the system shown in FIG. 1 displaying selected calendar information and deadlines related to a selected horse according to one embodiment of the present disclosure;

FIG. 7 is an exemplary illustration of a GUI of a webpage of the system shown in FIG. 1 displaying logbook related information for a selected horse according to one embodiment of the present disclosure;

FIGS. 8A and 8B are exemplary illustrations of a GUI of a webpage of the system shown in FIG. 1 displaying resume related information for a selected horse according to one embodiment of the present disclosure;

FIG. 9A is an exemplary illustration of a GUI of a webpage of the system shown in FIG. 1 displaying arena history information for a selected horse in chart form according to one embodiment of the present disclosure;

FIG. 9B is an exemplary illustration of a GUI of a webpage of the system shown in FIG. 1 displaying arena history information for a selected horse in tabular or list form according to one embodiment of the present disclosure;

FIG. 10 is an exemplary illustration of a GUI of a webpage of the system shown in FIG. 1 displaying a gallery for photos, videos, and sound recordings of a selected horse according to one embodiment of the present disclosure;

FIG. 11A is an exemplary illustration of a GUI of a webpage of the system shown in FIG. 1 displaying results from an analyzer module for a selected horse according to one embodiment of the present disclosure;

FIG. 11B is an exemplary illustration of a GUI of a webpage of the system shown in FIG. 1 displaying results from an analyzer module for a selected horse overlaid with supplement related information according to one embodiment of the present disclosure;

FIG. 11C is an exemplary illustration of a GUI of a webpage of the system shown in FIG. 1 displaying results from an analyzer module for a selected horse overlaid with supplement related information and showing a pop-up display box describing such information according to one embodiment of the present disclosure;

FIG. 11D is an exemplary illustration of a GUI of a webpage of the system shown in FIG. 1 displaying results from an analyzer module for a selected horse in spreadsheet form according to one embodiment of the present disclosure;

FIG. 11E is an exemplary illustration of a GUI of a webpage of the system shown in FIG. 1 displaying results from an analyzer module for a selected horse in spreadsheet form having multiple analysis options according to one embodiment of the present disclosure;

FIG. 11F is an exemplary illustration of a GUI of a webpage of the system shown in FIG. 1 displaying results from an analyzer module for a selected horse in tabular form and showing information sorted by association and related points according to spreadsheet form according to one embodiment of the present disclosure;

FIG. 12 is an exemplary illustration of a GUI of a webpage of the system shown in FIG. 1 displaying performance resumes according to one embodiment of the present disclosure; and

FIG. 13 is an exemplary illustration of a GUI of a webpage of the system shown in FIG. 1 displaying a selected performance resume according to one embodiment of the present disclosure.

### DETAILED DESCRIPTION

The present disclosure generally provides web-based data management and performance tracking systems and, in particular, online tracking systems that provide users the ability to manage horse-specific data and to track the performance of such horses to record, correlate, share, display, and compare such data and other related performance metrics.

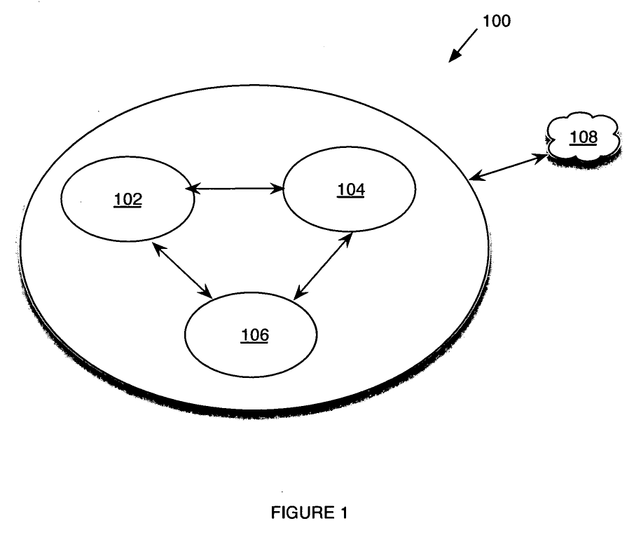

FIG. 1 is a somewhat simplified diagram illustrating an exemplary integrated web-based equestrian data management and performance metric correlation system 100 according to one embodiment of the present disclosure. System 100 could include data manager module 102, performance metric module 104, and miscellaneous module 106. It should be understood that system 100 is for illustrative purposes only and that any other suitable system or subsystem could be used in accordance with the present disclosure.

System 100 generally provides an integrated system to schedule, organize, store, track, and analyze in depth records for a particular horse or number of horses. System 100 could coordinate information related to a number of factors including a horse's feed, supplements, nutritional needs, nutritional intake, allergies, medical care, injuries, jockey information, trainer information, owner information, farrier, tack, track records, arena history, race schedules, race track conditions, weather, race times, split times, race winnings, total winnings, race averages, performance metrics, other suitable discrete factors or conditions, and any combination thereof. Different parts of system 100 log, record, store, and display these discrete factors in a number of customizable forms.

System 100 could also provide integrated analytics to aid in improving performance, tracking performance, improving strategies, isolating problems, discovering regimens or programs that work best or offer below-average performance, other suitable metrics, or any combination thereof. System 100 could offer such analytics in one or more charts, graphical displays, tabular formats, time-line like formats, pie chart displays, other suitable display forms, or any combination thereof. Accordingly, system 100 could provide a system and method of fine-tuning a particular horse's overall performance or performance at a particular arena, arena type, race type, division, or style of race.

An authorized user of system 100 can access an account associated with system 100, input information, create performance reports, view information graphically, or update data on system 100 via the web using any device configured to access the Internet including, for example, any stand alone computer, networked device or suitable mobile device.

System 100 could be associated with an Internet Protocol (IP) address or website 108. Although the following description describes system 100 for use in conjunction with equestrian-related information or data and, in particular, to horse-related information, it should be understood that system 100 and website 108 could be used in conjunction with information related to any competitive sport, event, athletic pursuit, animal training, other suitable application, or any combination thereof.

Similarly, it should be understood that data manager module 102, performance metric module 104, and miscellaneous module 106 are used for illustrative purposes only. System 100 could include any number of modules or combinations of modules in conjunction with or in lieu of data manager module 102, performance metric module 104, and miscellaneous module 106. Preferably, data manager module 102, performance metric module 104, and miscellaneous module 106 are configured to communicate with each other seamlessly without user intervention.

System 100 provides a trainer, owner, investor, casual observer, other suitable entity, or any combination thereof to record, analyze, compare, correlate, and share a horse's medical information, performance metrics, competitive activities, experiences, award history, sale price, owner information, and other related information using an Internet based system. For example, an owner of a race horse could use system 100 to enter and record all genealogical, medical, race times, tack usage, arena race conditions, and physical therapy regimens and correlate such information to prepare a comprehensive analysis of that race, horse's performance, and overall health. As a specific example, an owner could track whether a particular change in a medical supplement or nutritional intake affected the horse's performance over a particular time period or in a specific race. Other performance metrics could also be analyzed using system 100.

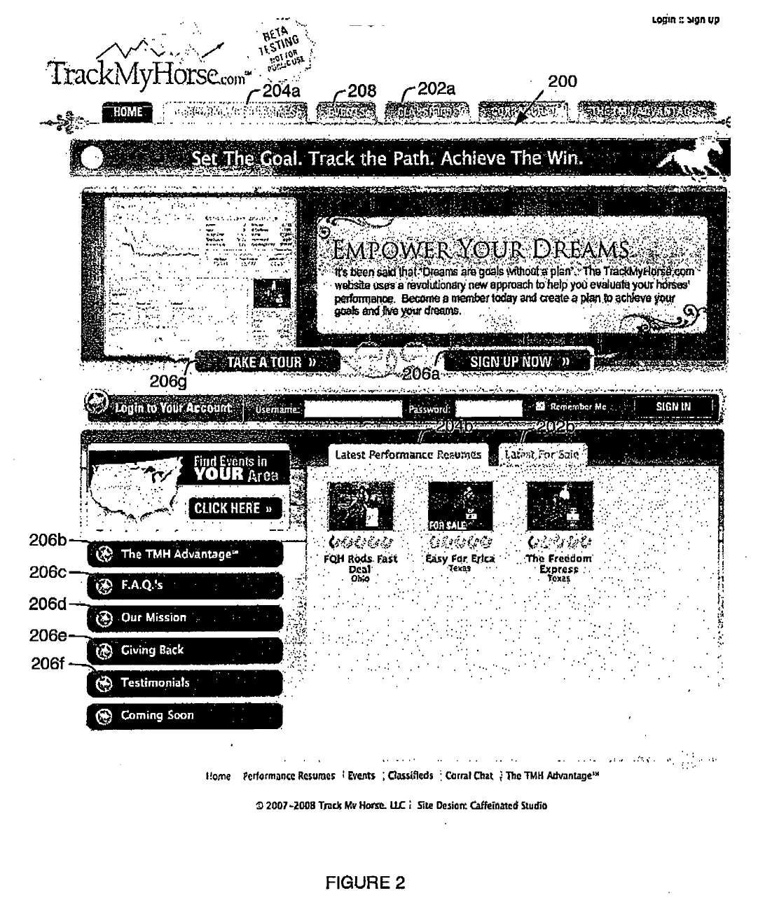

FIG. 2 is an exemplary illustration of a graphical user interface (GUI) of a home webpage 200 of system 100 according to one embodiment of the present disclosure. It should be understood that home webpage 200 is for illustrative purposes only and that any other suitable webpage could be used in accordance with the present disclosure.

Home webpage 200 could be generally accessible by any member of the public who has access to the Internet, including those who are not members of website 108. Home webpage 200 could include a number of links providing access to general information about system 100 including, for example, links to classified advertisements links 202a and 202b (collectively referred to herein as classified advertisements links 202), performance resumes links 204a and 204b (collectively referred to herein as performance resumes links 204), membership information links 206a, 206b, 206c, 206d, 206e, 206f, and 206g (collectively referred to herein as membership information links 206), events links 208. It should be understood that numerous other links to many other types of information or combinations of information could also be included on home webpage 200 in accordance with the present disclosure.

Classified advertisements link 202 could generally provide non-members and members of website 108 access to information related to items that are for sale, for free, available bartering offers, help-wanted solicitations, or other advertisements or announcements. Although all members of the public could view information associated with classified advertisements link 202, only members of website 108 could preferably post or otherwise list an advertisement or information on website 108. Additionally, in one embodiment, a member of website 108 could specify whether their particular listing or other information should be made available to any member of the public, only to other members of website 108, only to select members of website 108, or kept private.

Performance resumes link 204 could generally provide non-members and members of website 108 a link to information related to a particular horse in the form of a “performance resume” as discussed in detail later herein. Although members of the public could view the information associated with performance resumes link 204 in certain cases, in one embodiment, only members of website 108 could post or otherwise post a performance resume on website 108. Additionally, in one embodiment, a member of website 108 could specify whether their particular performance resume should be made available to any member of the public, only to other members of website 108, only to specific members of website 108, or kept private.

Membership information links 206 could generally provide non-members and members of website 108 access to information related to membership with website 108. Although all members of the public could view the information associated with membership information links 206, in one embodiment, only members of website 108 could have unrestricted access to materials associated with the link. For example, in one embodiment, website 108 could parse certain information associated with membership information link 206 and provide access to such information to any member of the public, only to other members of website 108, only to specific members of website 108, or kept private.

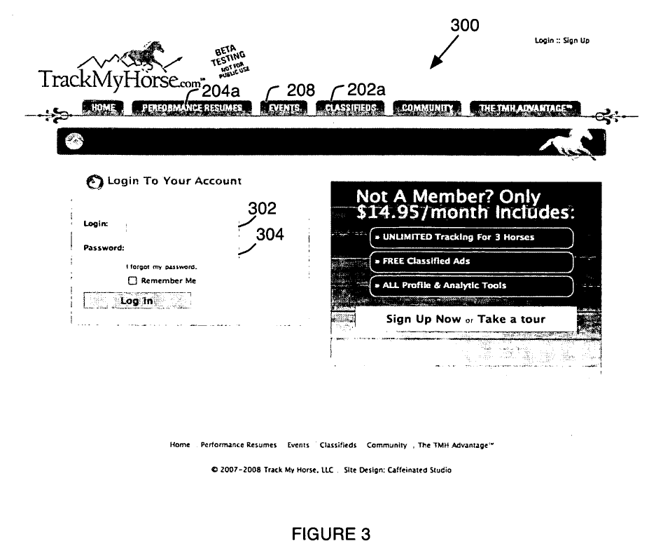

In general, system 100 provides the user the ability to enter data using various graphical user interfaces accessible over the Internet. As an example, system 100 could be accessible using a specific uniform resource locator (URL) associated with a particular website. The URL could point to log-in webpage 300 of the website and provide a user-accessible area to enter log-in, identification, or other account information as shown in FIG. 3.

FIG. 3 is an exemplary illustration of a GUI of a log-in webpage 300 of system 100 according to one embodiment of the present disclosure. It should be understood that log-in webpage 300 is for illustrative purposes only and that any other suitable log-in system, authorization system, authentication system, other suitable subsystem, or any combination thereof could be used in accordance with the present disclosure. For example, log-in webpage 300 could include biometric verification, voice recognition, retinal scans, fingerprint scanning, other suitable identification systems, or any combination thereof.

Log-in webpage 300 could require inputting certain account information including, for example, a log-in or username 302 and a password 304. If the user enters username 302 and password 304 on log-in webpage 300 that matches an authorized log-in or account information recognized by system 100, then system 100 allows the user access to the protected areas of the website and the user's account information associated with the website.

Once access is granted to the protected areas of the website, the user could use data manager module 102 to create, manipulate, track, correlate, analyze, or otherwise report the data into various reports, graphs, charts, data displays, tabular displays, performance resumes, other data correlating outputs, or any suitable combination thereof.

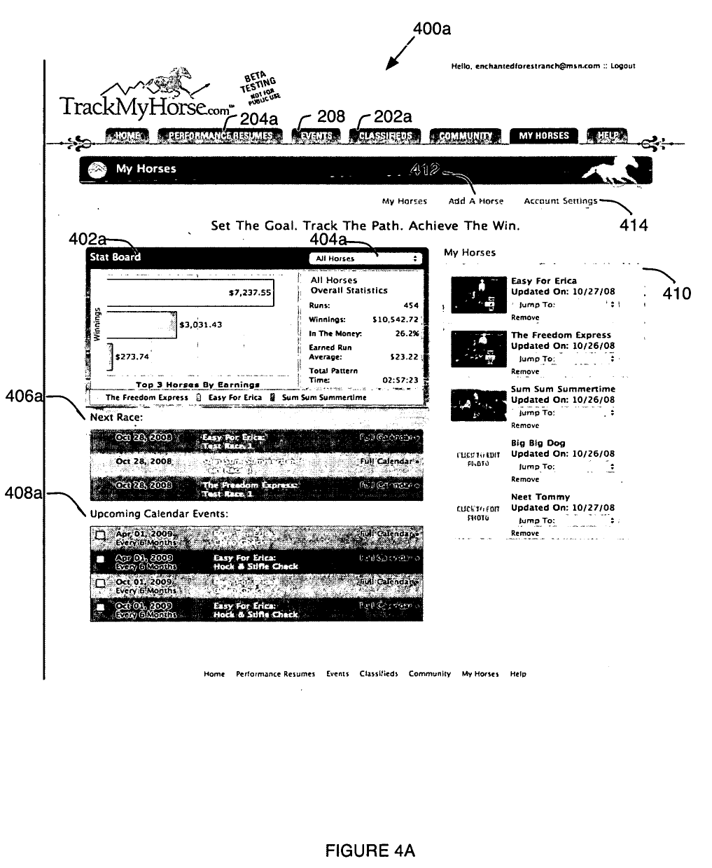

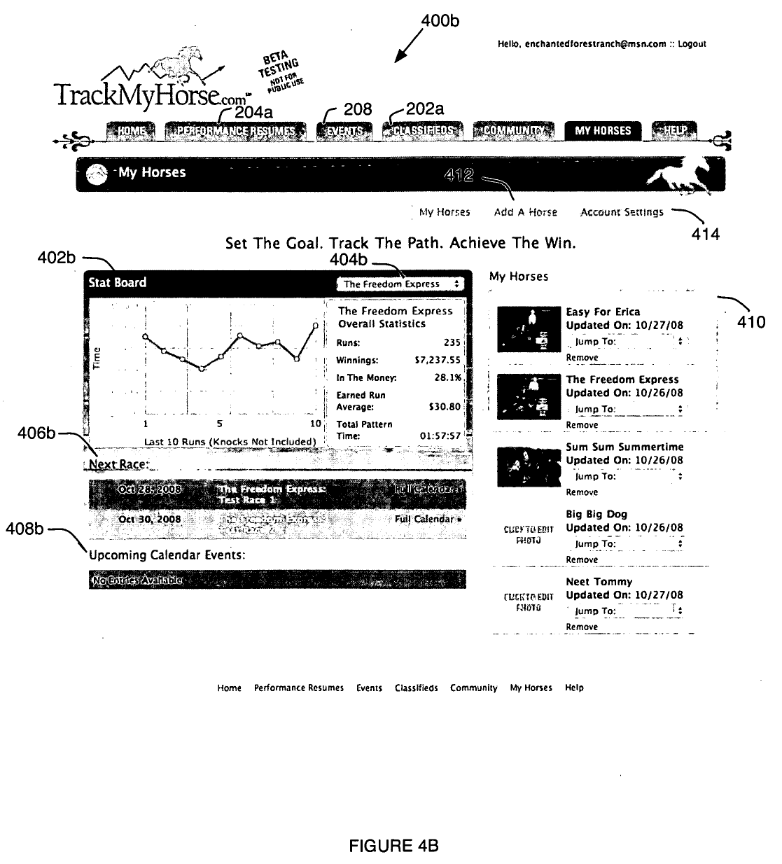

FIGS. 4A and 4B are exemplary illustrations of GUIs of “my horses” webpages 400a and 400b (collectively referred to herein at my horse webpage 400) of system 100 according to one embodiment of the present disclosure. It should be understood that my horses webpages 400 are for illustrative purposes only and that any other suitable webpages could be used in accordance with the present disclosure.

My horses webpages 400 generally allow the user to input, display, and correlate statistical and race information about a particular horse. Suppose a user of website 108 inputs information about three horses—Easy for Erica, The Freedom Express, and Sum Sum Summertime. Statistical board module 402a in FIG. 4A could display information for all three horses in a graphical display by choosing “All Horses” from a data selector 404 as shown in my horses webpage 400a in FIG. 4A. Although data selector 404 is shown as a drop down menu, it should be understood that data selector 104 could use any suitable system of choosing the data such as, for example, a point and click selector, a link, or button selector. In another example, suppose the user selects the horse “The Freedom Express” using data selector 404, as shown in FIG. 4B. Statistical board module 402b could then selectively display information for just The Freedom Express.

Statistical board modules 402a and 402b (collectively referred to herein as statistical board modules 402) could graphically display statistics such as, for example, race winnings information, the number of runs completed, total winnings information, in the money percentages, earned run averages, total pattern times, other suitable race related data, or any combination thereof. Although some of the information in statistical board modules 402 is shown using either a bar or line graph, it should be understood that the display could show the information in any suitable format and could be customizable by the user as desired.

Next race module 406a and 406b (collectively referred to herein as next race module 406) could list or otherwise display the next race that the selected horse or horses could participate in or eligible to race in. The dates of such races could also be selectively displayed on a calendar, if desired.

Upcoming calendar events modules 408a and 408b (collectively referred to as upcoming calendar events module 408) could list or otherwise display upcoming scheduled event for the selected horse or horses. These events could include medical events, supplement events, feed related events, appointments, tack changes, farrier maintenance events, physical therapy events, other suitable events, or any combination thereof.

My horse module 410 organizes and display all horses associated with the user of website 108. For example, suppose the user selects “The Freedom Express,” then as shown in FIG. 4B, my horses webpage 400b displays only information associated with The Freedom Express in statistical board module 402b, next race module 406b, and upcoming calendar events module 408b. In one embodiment, the user could select two or more horses and display their respective information at any one given time period on my horses webpages 400. Accordingly, the user has the ability to selectively display information for one or more horses at any given time.

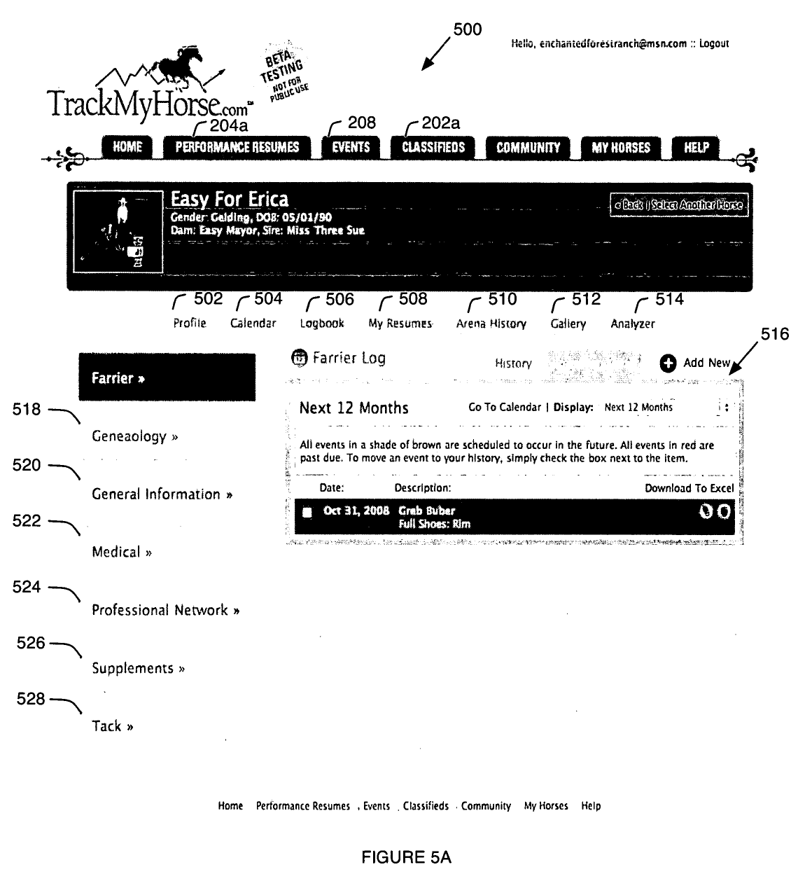

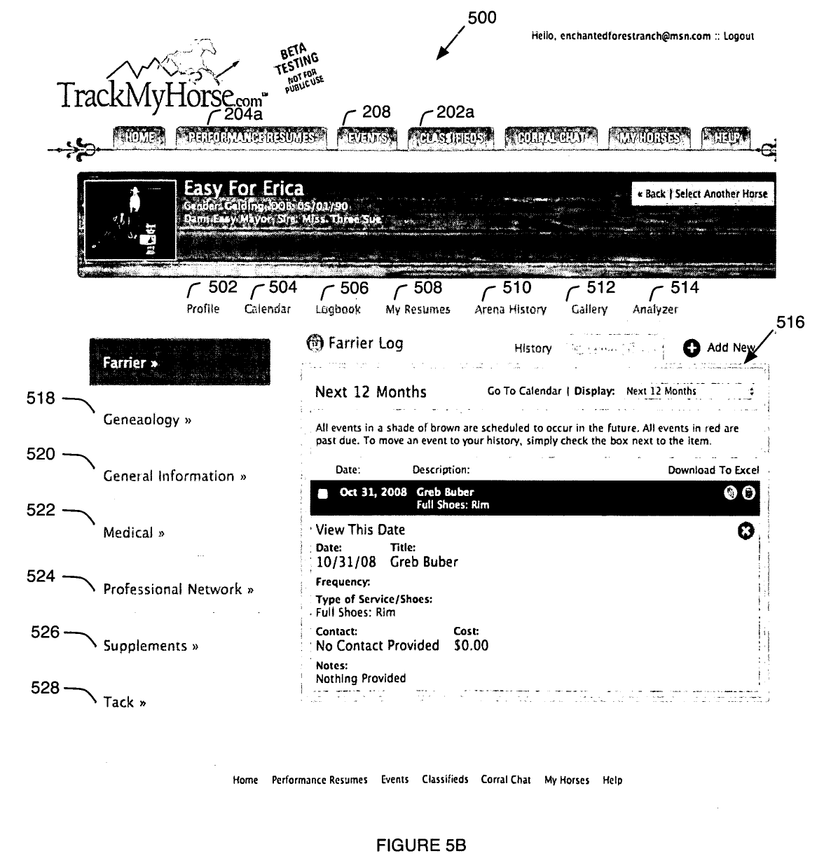

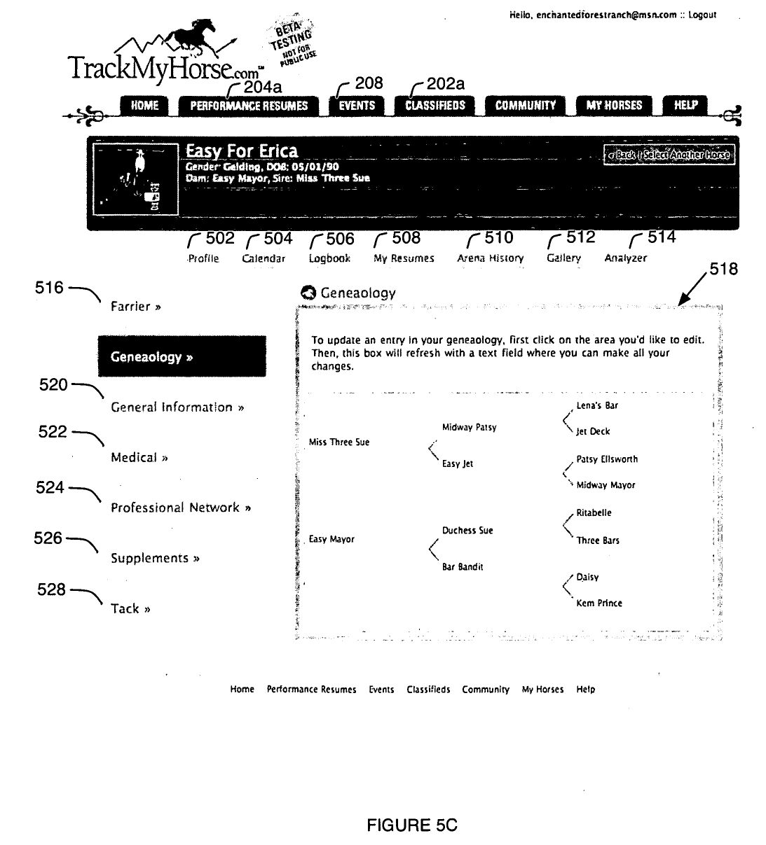

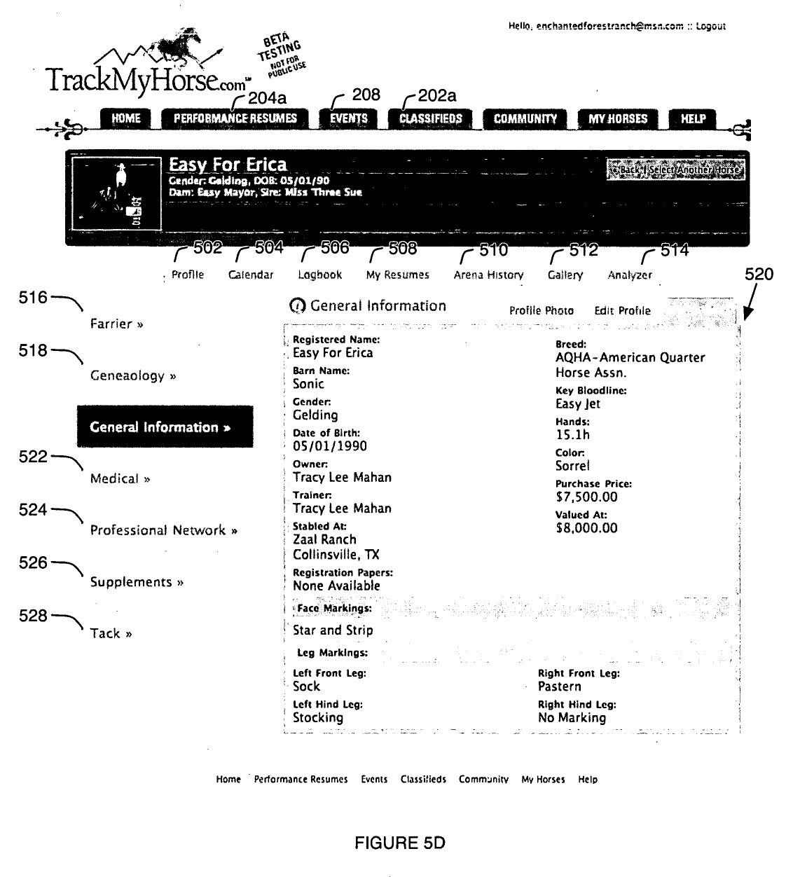

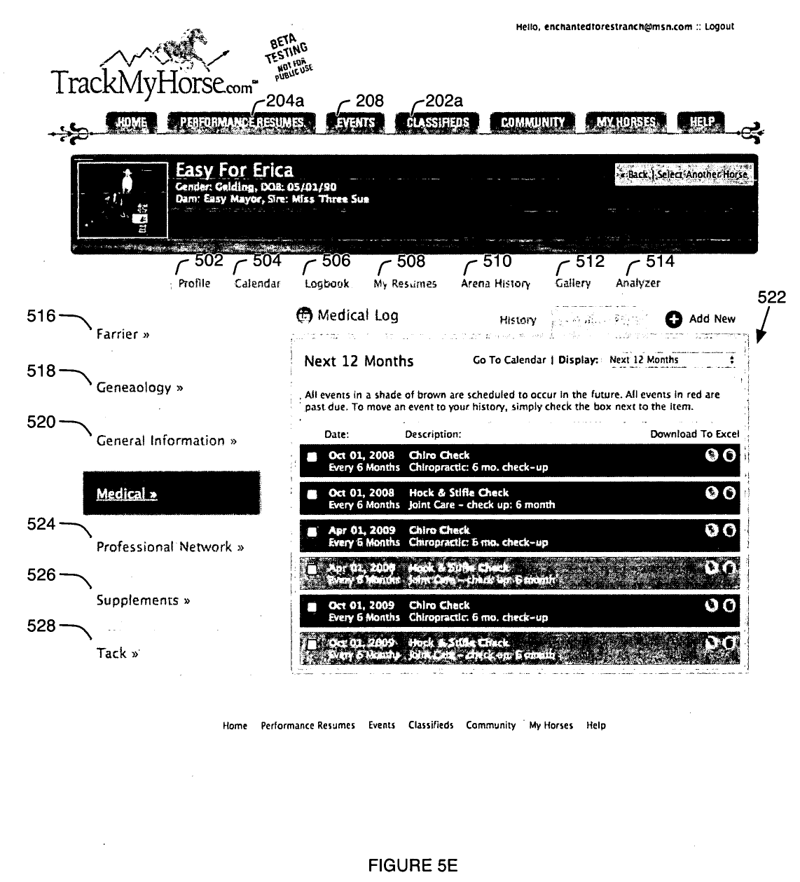

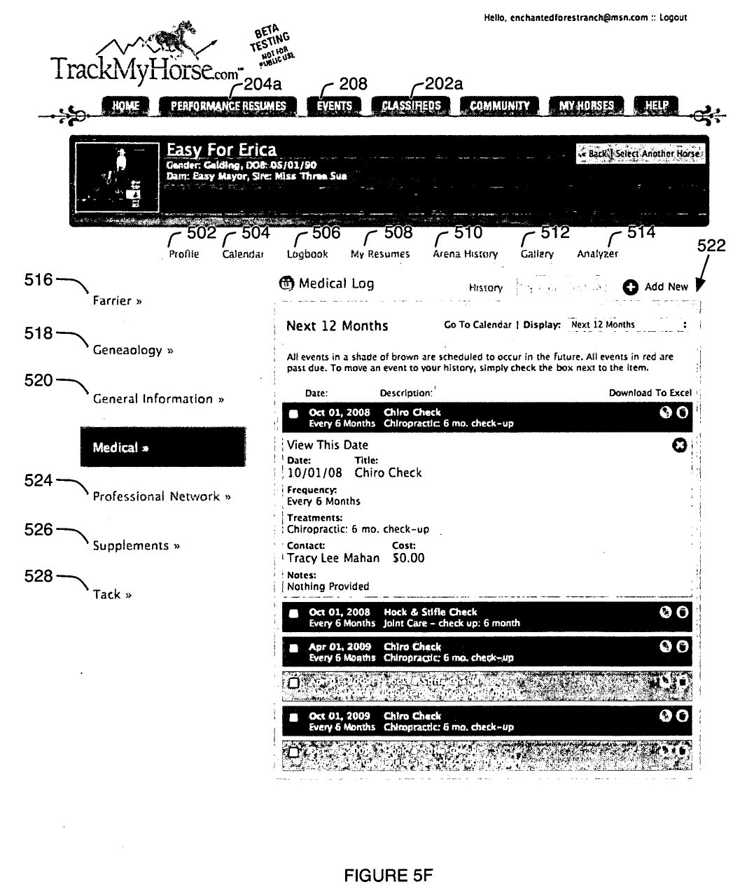

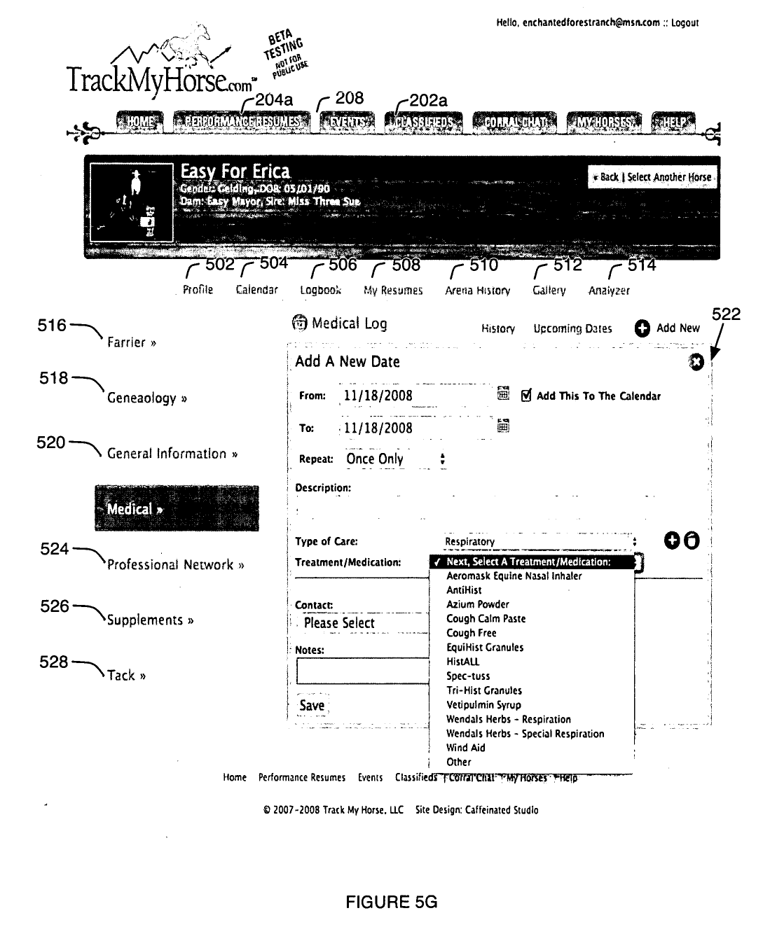

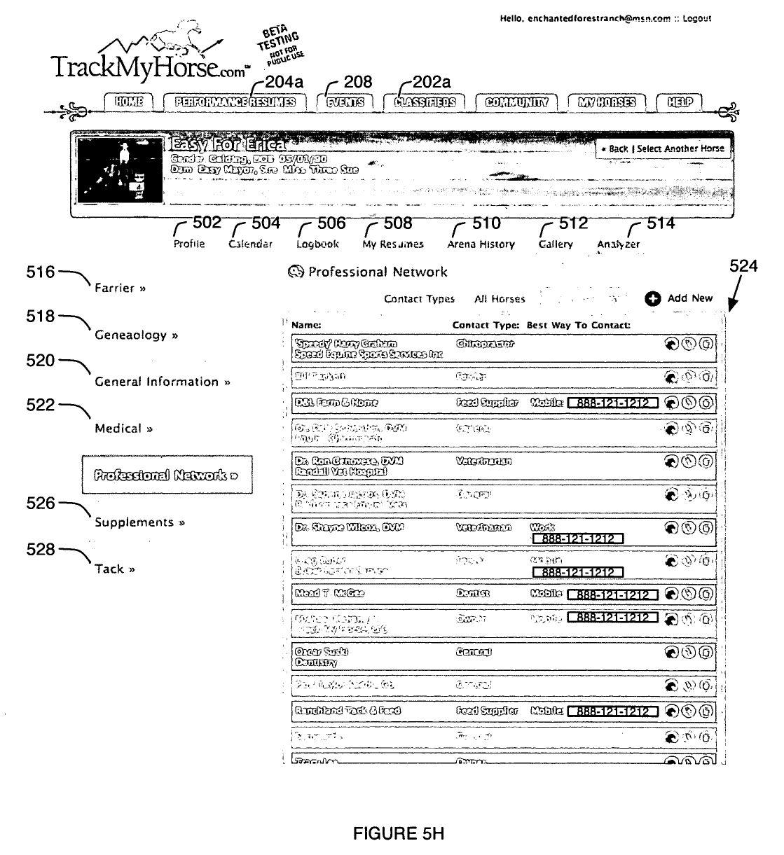

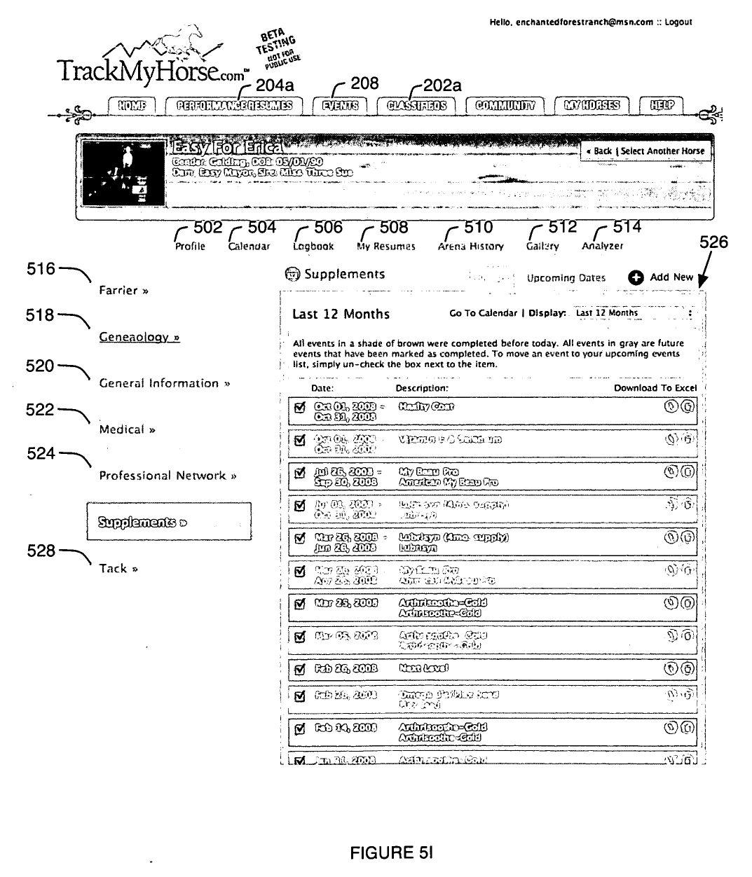

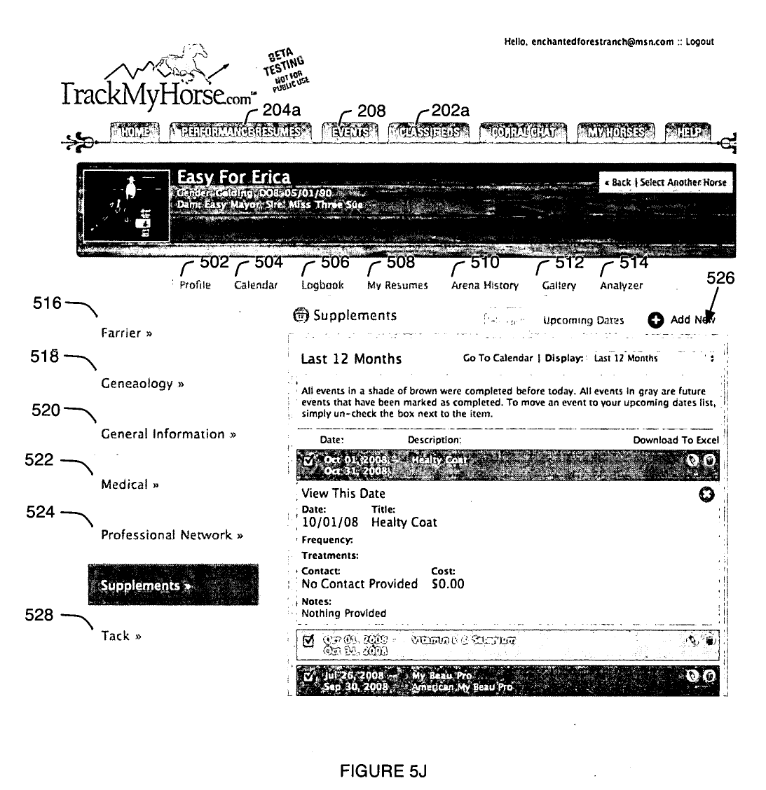

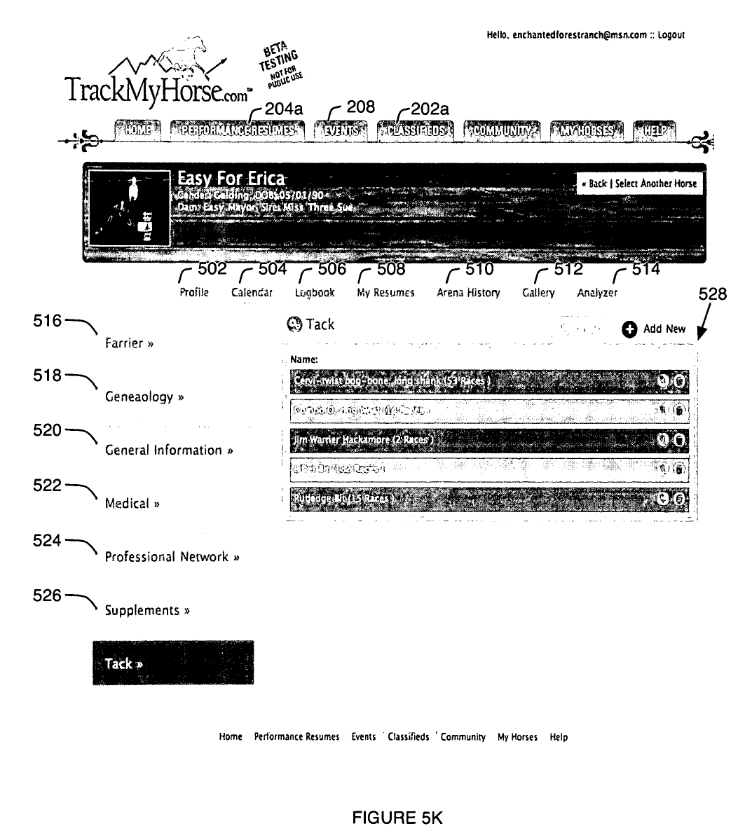

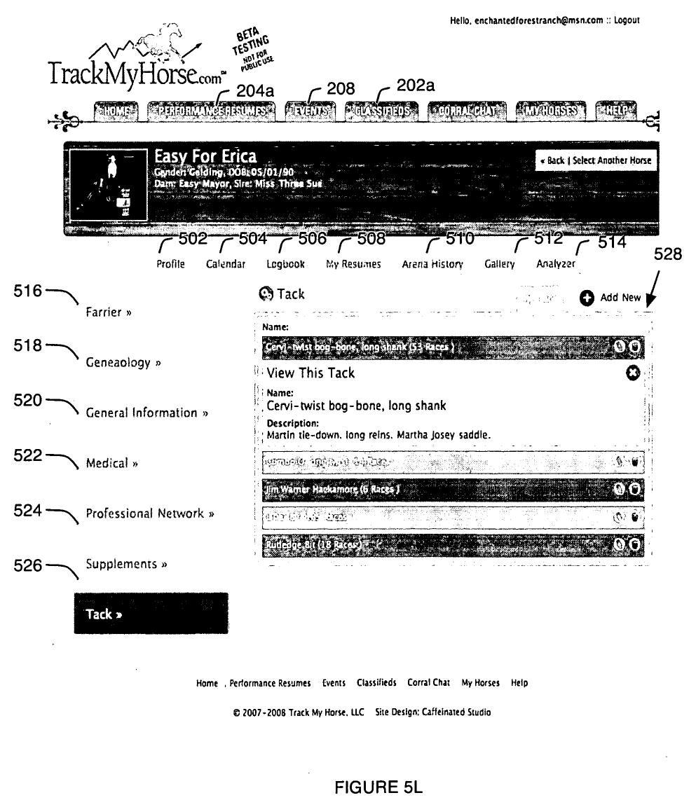

Add horse module 412 could allow the user to add a horse and its associated information to the user's individual account on system 100. In addition, using account setting module 414, the user could specify certain criteria or specifications controlling the display of data, data correlation, data updates, other features, or combination of specifications thereof. For example, when adding a horse to system 100, the user could use profile module 502, calendar module 504, logbook module 506, my resumes modules 508, arena history module 510, gallery module 512, and analyzer module 514 shown in FIGS. 5, 6, 7, 8, 9, 10, and 11, respectively, to enter such information.

FIGS. 5A, 5B, 5C, 5D, 5E, 5F, 5G, 5H, 5I, 5J, 5K, and 5L (collectively referred to as FIG. 5) are exemplary illustrations of GUIs associated with the profile module 502 according to one embodiment of the present disclosure. Profile module 502 provides the user the ability to input information associated with a particular horse. For example, profile module 502 could include farrier module 516, genealogy module 518, general information module 520, medical module 522, professional network module 524, supplements module 526, tack module 528, other suitable module, or any combination thereof. In one embodiment, profile module 502 interacts with calendar module 504 and analyzer module 514 providing a relatively simple, accurate way to manage information related to one or more horses associated with the user or the account.

Farrier module 516 shown in FIG. 5A is associated with profile module 502 and could include any information related to or associated with a horse's farrier or equine hoof and foot care. For example, a user could input a date reminder for when a farrier needs to perform a particular treatment or if, for example, a shoe needs replacement, maintenance, or other event. Information stored in or associated with farrier module 516 could be correlated, downloaded, or otherwise prepared in a report, summary, chart, or spreadsheet form. It should be understood that farrier module 516 shown in FIG. 5A is for illustrative purposes only and that any other suitable embodiments of farrier module 516 could be used in accordance with the present disclosure.

FIG. 5B is an exemplary illustration of a GUI displaying expanded farrier information associated with farrier module 516 for a selected horse according to one embodiment of the present disclosure. The expanded information could include date, title, frequency, type of service, shoe, or service, contact information, notes, associated costs, any other suitable information related to farrier information, or any combination thereof. In one embodiment, the expanded information could include an automatically populated field related to certain farrier information. As one example, the user could enter farrier information about a certain horseshoe in farrier module 516. An automatically populated field could be provided to offer different variations, brand names, sizes, categories, or quality types of horseshoes associated with the inputted information. It should be understood that an automatically populated field could be provided for any suitable information entered by the user using farrier module 516.

Genealogy module 518 shown in FIG. 5C is associated with profile module 502 and could include information related to family history, bloodlines, and other lineage related information. The information could be listed in any suitable form such as, for example, graphically (as shown in FIG. 5B), list form, chart, bubble diagram, tabular form, any other formats, or any combination thereof. It should be understood that genealogy module 518 shown in FIG. 5B is for illustrative purposes only and that any other suitable embodiments of genealogy module 518 could be used in accordance with the present disclosure.

In one embodiment, genealogy module 518 could provide a quick reference to store information about a particular horse's pedigree. For example, to update an entry, the user simply clicks on the name of the horse you want to edit and the screen will refresh the text field at the top of the chart where the user could make changes. Information stored in or associated with genealogy module 518 could be correlated, downloaded, or otherwise prepared in a report, summary, chart, or spreadsheet form.

In one embodiment, the expanded information could include an automatically populated field related to certain genealogical information input in genealogy module 518. As one example, the user could enter information about a certain lineage and an automatically populated field could be provided to offer different information associated with the inputted information. It should be understood that an automatically populated field could be provided for any suitable information entered by the user into genealogy module 518.

General information module 520 shown in FIG. 5D is associated with profile module 502 and could include information related to the horse's registered name, barn name, gender, data of birth, owner, trainer, stable information, registration papers, face markings, leg marking, breed, key bloodline, hand information, color, purchase price, current value, any other suitable information, or any combination thereof. It should be understood that general information module 520 shown in FIG. 5D is for illustrative purposes only and that any other suitable embodiments of general information module 520 could be used in accordance with the present disclosure.

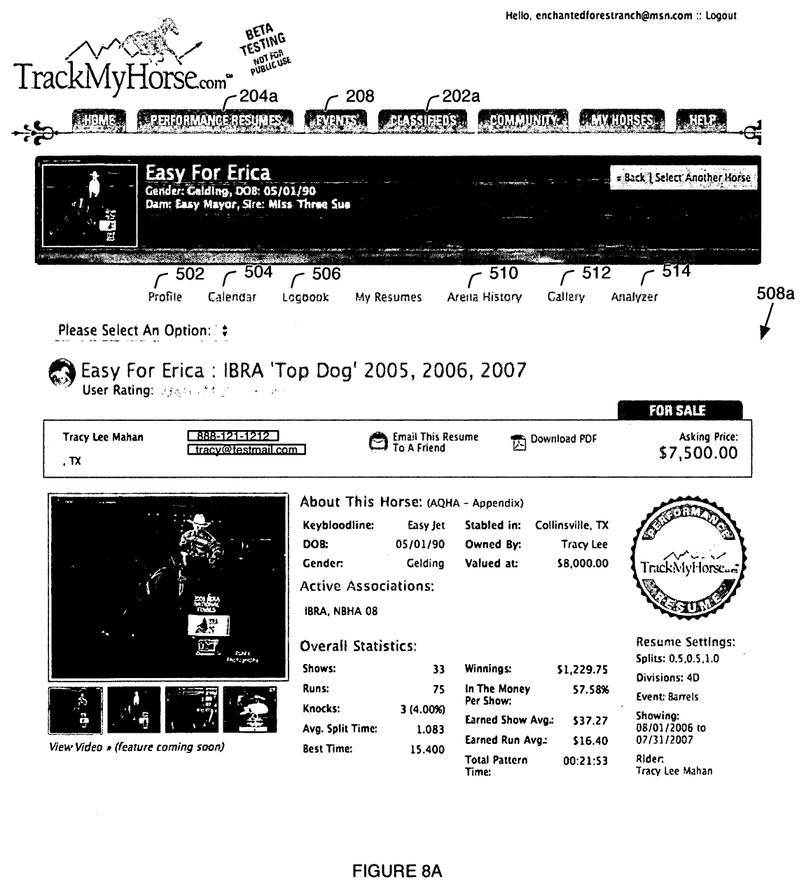

In one embodiment, general information module 520 could be the default page where the user could see a detailed description of a particular horse including physical markings, a downloaded registration form or verification, and other key descriptive elements. General information module 520 allows the user to make changes to a horse's profile and adjust critical components that could eventually be used in a performance resume as shown in FIGS. 8A and 8B. General information module 520 could also allow a user to upload a profile photo associated with a particular horse and link that photo so that it could be featured or otherwise displayed with the horse throughout website 108. Information stored in or associated with general information module 520 could be correlated, downloaded, or otherwise prepared in a report, summary, chart, or spreadsheet form.

Medical module 522 shown in FIGS. 5E, 5F, and 5G are associated with profile module 502 and could include information related to the horse's medical history, medical conditions, any treatment dates, therapy treatments, dietary restrictions, doctor/veterinary appointments, chiropractic treatments, medications, vaccines, other medical related events, or combination thereof. For example, as shown in FIG. 5E, a date reminder for when a particular treatment needs to take place could be entered in medical module 522 and displayed under the “Upcoming Dates” tab. Past medical reminders could be viewed under the “History” tab. Information stored in or associated with medical module 522 could be correlated, downloaded, or otherwise prepared in a report, summary, chart, or spreadsheet form. It should be understood that medical module 522 shown in FIGS. 5E, 5F, and 5G are for illustrative purposes only and that any other suitable embodiments of medical module 522 could be used in accordance with the present disclosure.

In another example, as shown in FIG. 5F, an expanded view of a date reminder for when a particular treatment needs to take place could be entered in medical module 522 and displayed under the “Upcoming Dates” tab. Additional information such as the frequency of the treatment, detailed instructions, contact information, and notes could be included as shown in FIG. 5F. Past medical reminders and expanded information could be viewed under the “History” tab. It should be understood that medical module 522 shown in FIG. 5F is for illustrative purposes only and that any other suitable embodiments of medical module 522 could be used in accordance with the present disclosure.

FIG. 5G is an exemplary illustration of a GUI displaying expanded medical related information associated with medical module 522 having an automatic population feature about a selected horse according to one embodiment of the present disclosure. The expanded information could include an automatically populated field related to certain medical information. As one example, the user could enter medical information related to the type of care needed. An automatically populated field could be provided to offer different variations, categories, subcategories, brand names of medicines, types of medicines, or other relevant information associated with the inputted information. It should be understood that an automatically populated field could be provided for any suitable information entered into medical module 522 by the user of system 100. As a specific example, medical module 522 could display multiple brand names of respiratory related medicines when a user selects “respiratory” as the type of care desired, as shown in FIG. 5G.

Professional network module 524 shown in FIG. 5H is associated with profile module 502 and could include information related to professionals who care for or are somehow associated with a particular horse. For example, the user could input information such as name, contact type, description of contact relationship, preferred method of contacting the professional, phone, email, address, facsimile number, other suitable contact information, or any combination thereof. Information stored in or associated with professional network module 524 could be correlated, downloaded, or otherwise prepared in a report, summary, chart, or spreadsheet form. It should be understood that professional network module 524 shown in FIG. 5H is for illustrative purposes only and that any other suitable embodiments of professional network module 524 could be used in accordance with the present disclosure.

In one embodiment, professional network module 524 could be a detailed listing of the entire business network that surrounds a user's horse. For example, by clicking on the “add new tab” link, a user could insert a new contact into their network. At the bottom of that listing is a unique contact manager that allows the user to assign a particular contact to multiple horses at the same time and then assign specific responsibilities for that contact to each horse in their network. In one embodiment, this function could be edited separately by selecting the small horse icon to the right of each contact listing. The user could also selectively choose to view all their contacts at once or just those for a specific horse. In one embodiment, the user could select the contact types link and add specialized contacts into their network. Those contacts listed in grey could automatically be placed in the system and the ones listed in brown are the new contact types created by the user.

Supplements module 526 shown in FIG. 5I is associated with profile module 502 and could include information related to the horse's supplement and vitamin history, supplement treatments, vitamin regimen, dietary/nutritional restrictions, electrolyte intake, protein enhancements, nutritional intake, allergens, other related events, or combination thereof. For example, as shown in FIG. 5I, a date reminder for when a particular supplement or nutritional intake needs to be administered or for when a related event needs to take place could be entered in supplements module 526 and displayed under the “Upcoming Dates” tab. Past reminders could be viewed under the “History” tab. Information stored in or associated with supplements module 526 could be correlated, downloaded, or otherwise prepared in a report, summary, chart, or spreadsheet form. It should be understood that supplements module 526 shown in FIG. 5I is for illustrative purposes only and that any other suitable embodiments of supplements module 526 could be used in accordance with the present disclosure.

FIG. 5J is an exemplary illustration of a GUI displaying expanded supplement related information associated with supplements module 526 and related to a selected horse according to one embodiment of the present disclosure. As one example, the user could enter supplement related information such as the date, title, frequency desired, treatment, contact information, costs, notes, other suitable information, or any combination thereof. The expanded information could include an automatically populated field related to certain supplements and provide the ability to choose from different pre-stored variations, categories, subcategories, brand names of supplements, types of supplements, or other relevant information associated with the inputted information in supplements module 526.

Tack module 528 shown in FIG. 5K is associated with profile module 502 and could include any information related to or associated with a horse's saddle, equipment, or other equine required materials. Tack module 528 could include a list of all equipment used by a particular horse in a race or through a particular season. In one embodiment, a date reminder for when a piece of equipment could need replacement, maintenance, or other event could be entered in tracked in tack module 528.

Data in tack module 528 could be correlated with race information and analyzed to see what equipment improved performance or, conversely, analyze what equipment could have negatively affected the horse's performance. Information stored in or associated with tack module 528 could be correlated, downloaded, or otherwise prepared in a report, summary, chart, or spreadsheet form. It should be understood that tack module 528 shown in FIG. 5K is for illustrative purposes only and that any other suitable embodiments of tack module 528 could be used in accordance with the present disclosure.

In one embodiment, tack module could allow the user to keep track of the various tack combinations used on a particular horse. For example, the user could supply a custom name to the setup used and provide a description associated with that setup. This information could be used by logbook module 506 to track how different tack combinations affect the user's performance.

FIG. 5L is an exemplary illustration of a GUI displaying expanded tack information related to tack module 528. As one example, the user could enter tack related information such as the name, description, date, title, frequency desired, maintenance schedule, contact information, costs, notes, other suitable information, or any combination thereof. The expanded information could include an automatically populated field related to certain tack information and provide the ability to choose from different pre-stored variations, categories, subcategories, brand names of tack equipment, types of tack, or other relevant information associated with the inputted information in tack module 528.

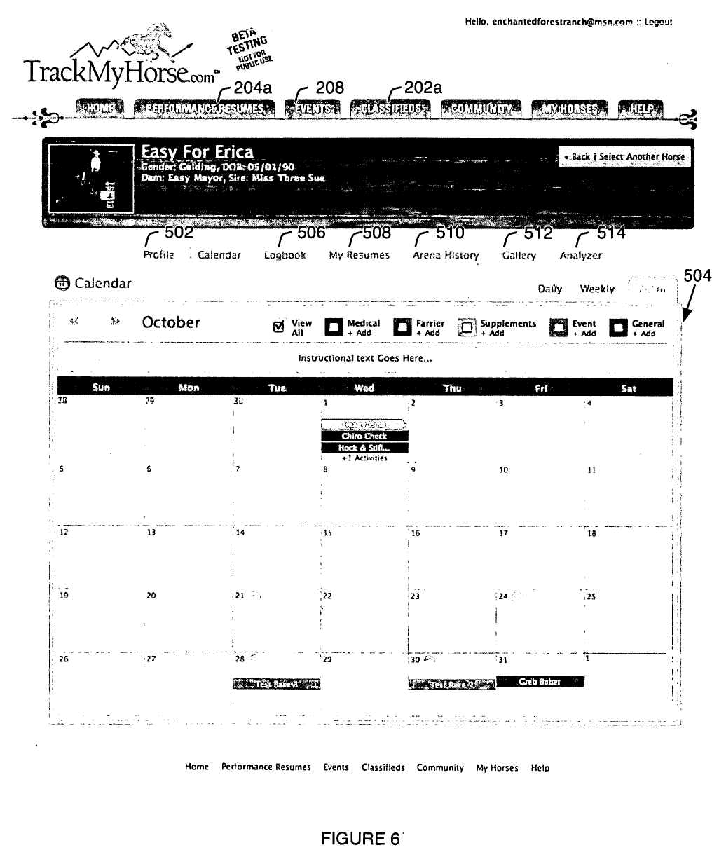

FIG. 6 is an exemplary illustration of a GUI associated with calendar module 504 according to one embodiment of the present disclosure. It should be understood that calendar module 504 shown in FIG. 6 is for illustrative purposes only and that any other suitable modules, GUIs, or webpages could be used in accordance with the present disclosure.

In one embodiment, calendar module 504 displays all the items scheduled in a particular horse's profile associated with profile module 502. Calendar module 504 could include a daily, weekly, monthly, or yearly view displaying appointments, reminders, or other events related to a particular horse or any number of horses associated with that particular user or account. For example, the appointment, reminder or other event could be related to one or more medical, farrier, supplement, nutritional intake, allergens, arena, race, training, or general event for a particular horse. Each type of event or information related to a particular horse could be color-coordinated or otherwise designated uniquely and selectively displayed according to a user's preference. Information stored in or associated with calendar module 504 could be correlated, downloaded, or otherwise prepared in a report, summary, chart, or spreadsheet form.

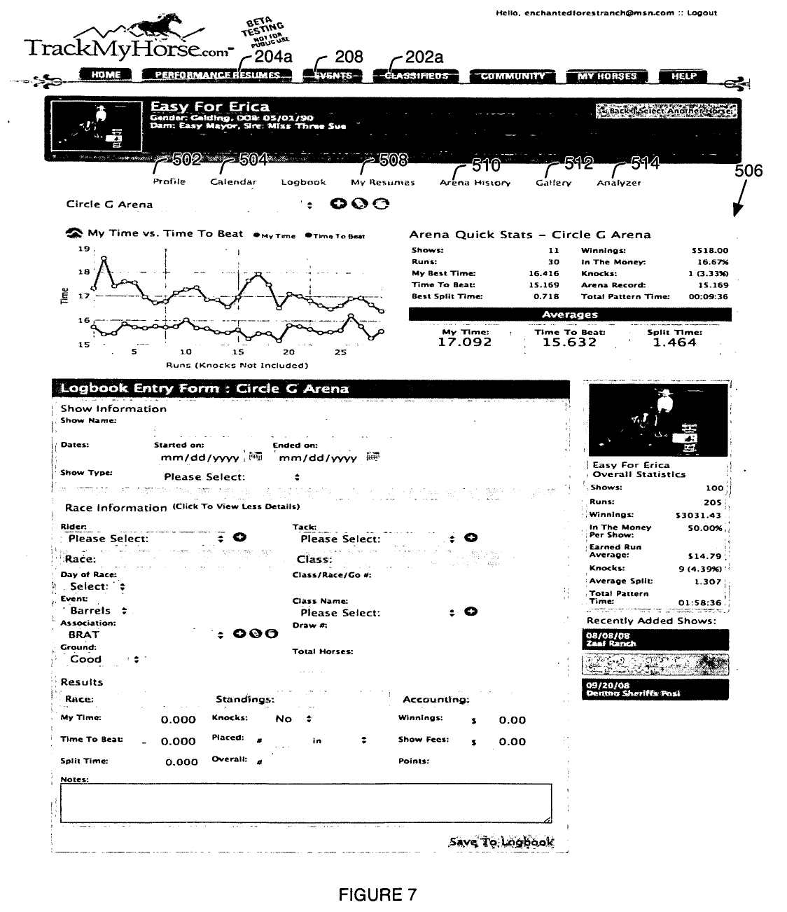

FIG. 7 is an exemplary illustration of a GUI associated with logbook module 506 according to one embodiment of the present disclosure. It should be understood that logbook module 506 shown in FIG. 7 is for illustrative purposes only and that any other suitable modules, GUIs, or webpages could be used in accordance with the present disclosure.

In one embodiment, logbook module 506 allows the user to input information about a horse's performance in shows, races, and any results related information. The user could select a particular horse and enter horse-specific data and select or create the arena where the user attended the show. At this point, logbook module 506 could provide the user with a fillable form to input the data. In one embodiment, the user could create a show name and date range for that show and then log individual race results.

In one embodiment, the user could adjust the amount of detail shown on each page associated with the logbook module 506. A “View Less Details” tab or link could control the display and allow the user to limit the amount of information on the display. Similarly, an “Add More Detail” tab or link could control the display and allow the user to view relatively more information.

In one embodiment, logbook module 506 could store and sort information about each race conducted at a particular show, for example, first by date and then by class number. Once a user saves an entry, logbook module 506 automatically resets the entry form and is ready to accept the results for the next race.

In one embodiment, the user could organize the data entry by first inputting results by horse, then by arena, and finally by show. As the user enters your race history for a given arena, logbook module 506 could keep a running list on the entry form to help the user stay organized and keep track of the data entry. In one embodiment, logbook module 506 could be associated with a number of quick reference statistics that help keep the user up-to-date on all entries, while building a performance history for each horse. Information stored in or associated with logbook module 506 could be correlated, downloaded, or otherwise prepared in a report, summary, chart, or spreadsheet form.

FIGS. 8A and 8B are exemplary illustrations of a GUI associated with my resumes modules 508a and 508b (collectively referred to herein as my resume module 508) according to one embodiment of the present disclosure. It should be understood that resumes module 508 shown in FIGS. 8A and 8B is for illustrative purposes only and that any other suitable modules, GUIs, or webpages could be used in accordance with the present disclosure.

My resumes module 508 uses information gathered from a combination of other areas of system 100. For example, my resumes module 508 could create performance resumes at any time as long as there is data in system 100. My resumes module 508 could gather information from a combination of areas in system 100 including, for example, horse profile module 502, logbook module 506, arena history module 510, and gallery module 512. Information stored in or associated with my resumes module 508 could be correlated, downloaded, or otherwise prepared in a report, summary, chart, or spreadsheet form.

In one embodiment, a user could create many performance resumes for a given horse as desired and pick and choose which resumes to post for public viewing. In one embodiment, the user could control what data will be available for public by, for example, choosing a particular date range, rider, divisional split, other suitable criteria, or combination thereof. The customized performance resume could be easily modified, saved, and posted to a publicly accessible area of system 100. In one embodiment, the user could be required to certify the authenticity of the data and validate the percentage of runs represented by the performance resume. By certifying or requiring validation, system 100 facilitates a system in which the information could be relied upon by investors, potential buyers, and other interested parties.

In one embodiment, my resumes module 508 could include a search option in which a user could for any name, ranch, horse, other suitable search criteria, or any combination thereof and find all performance resumes matching the search criteria. Accordingly, the user of website 108 could search for a number of different horses, horse types, arenas, race information, or other related information based on the search criteria entered in my resumes module 508. As an example, suppose the user desired to find all horses that raced at a particular show in 2007. The search option feature in my resumes module 508 could enable such a search.

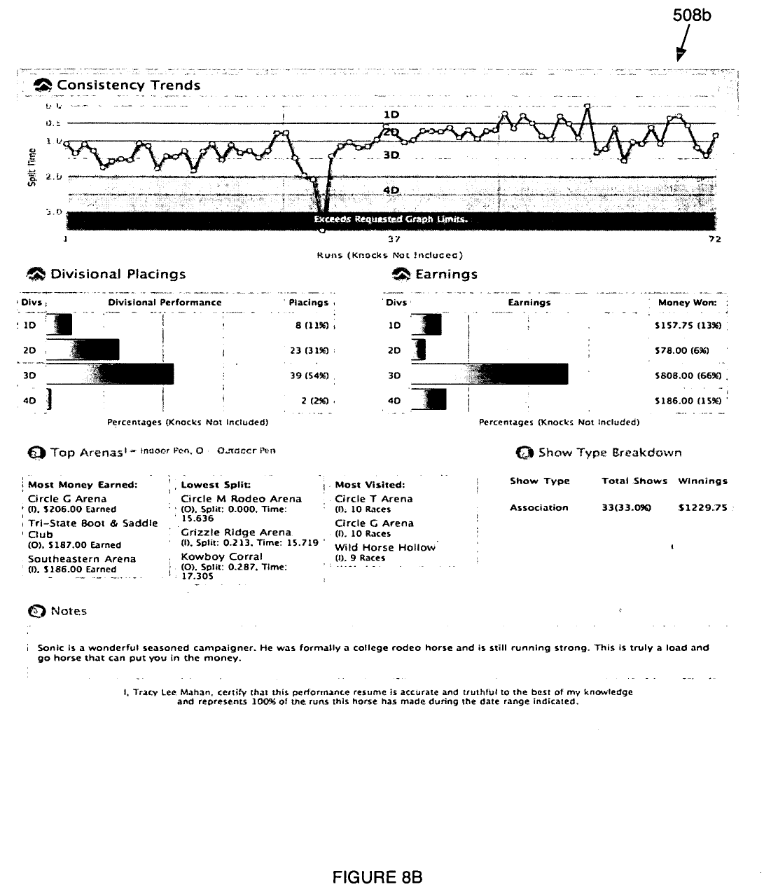

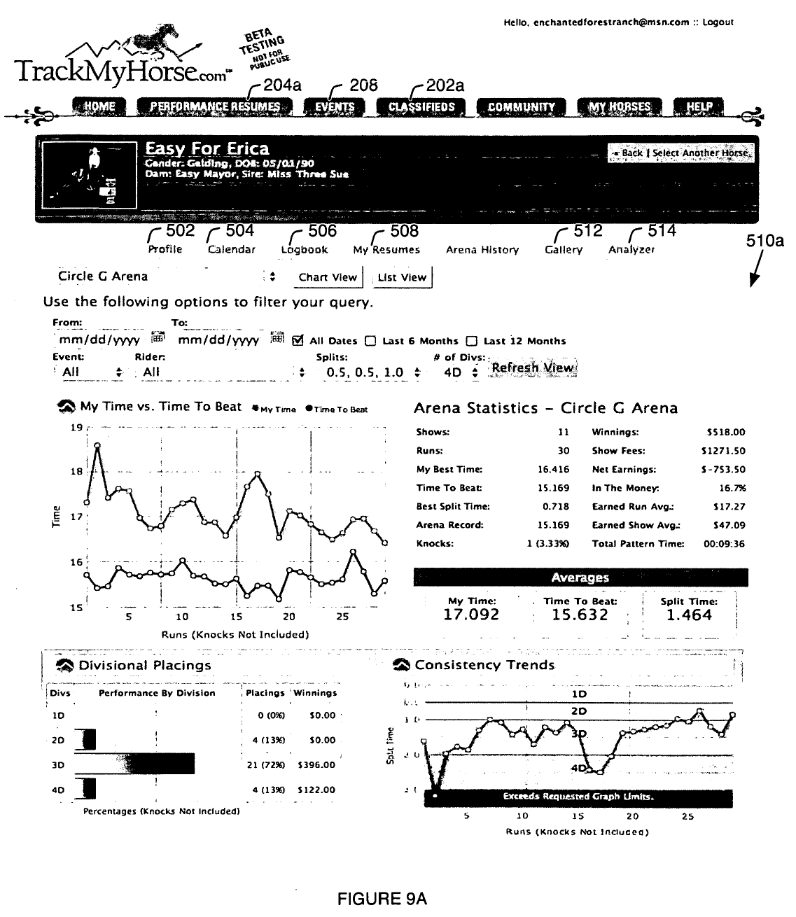

FIGS. 9A and 9B are exemplary illustrations of a GUI associated with arena history module 510 according to one embodiment of the present disclosure. It should be understood that arena history module 510 shown in FIGS. 9A and 9B is for illustrative purposes only and that any other suitable modules, GUIs, or webpages could be used in accordance with the present disclosure.

Arena history module 510 provides a relatively simple to understand graphic illustration of how a particular horse is performing in a given arena. In one embodiment, arena history module 510 provides the user the ability to analyze the horse's performance history based on many different factors, for example, date, event, rider, and divisional splits based on data correlated from logbook module 506. The data for all races entered in each arena could be viewed in list form using a link or tab labeled “List View.” The information could include be displayed in a number of customizable formats including, for example, a display in which the information is sorted or categorized by show or date order. Information stored in or associated with arena history module 510 could be correlated, downloaded, or otherwise prepared in a report, summary, chart, or spreadsheet form.

In one embodiment, the list could include a set of average statistics for all the runs a user participated in during a particular show. By clicking on the icon to the left of the show date, the user has the ability to view the detailed entries made for each run. In one embodiment, a “Show All Races” tag or link displays all the races in every show and displays the show dates and averages on one line (say a brown line) and the individual runs on another line (say green lines). It should be understood that any visually distinctive system could be used to differentiate between averages related data and individual run related data such as color coding, line differentiations, dotted versus solid lines, icons, other suitable system, or any combination thereof. A “Hide All Races” tab or links reverts back to the list of the shows the user entered for that arena. It should be understood that any number of other options to display, manipulate, or other control the data or information could be used in accordance with the present disclosure.

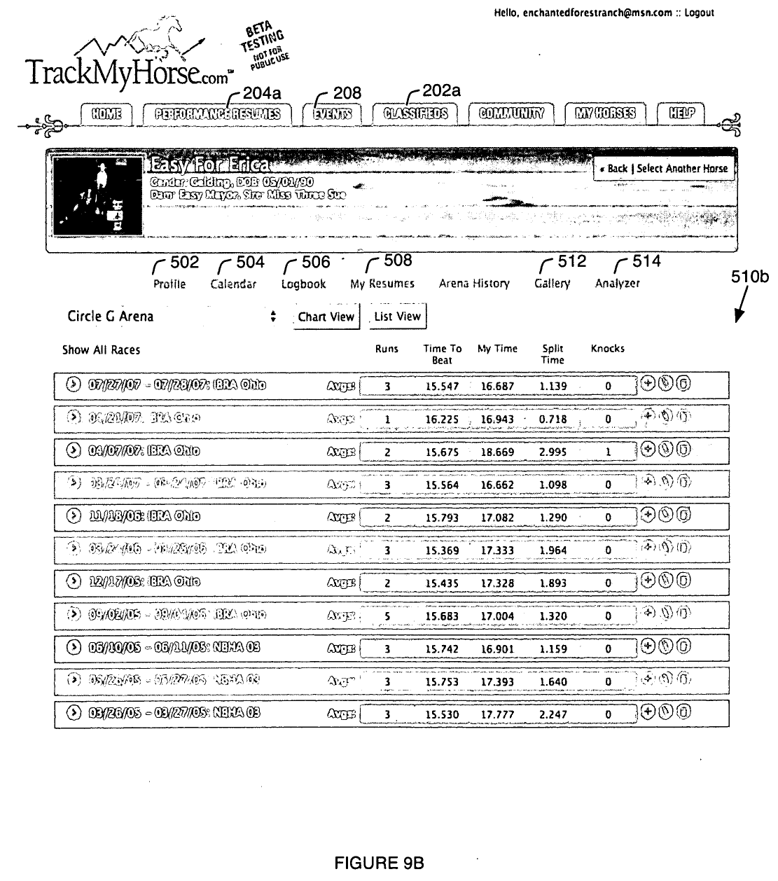

FIG. 10 is an exemplary illustration of a GUI associated with gallery module 512 according to one embodiment of the present disclosure. It should be understood that arena history module 510 shown in FIG. 10 is for illustrative purposes only and that any other suitable modules, GUIs, or webpages could be used in accordance with the present disclosure.

Gallery module 512 provides the user with an interface to easily upload and store photos, videos, and sound files. Gallery module 512 could also provide the user with the ability to create albums and store them for quick reference. In one embodiment, gallery module 512 could share certain photo, video, or sound files with a particular performance resume. Information stored in or associated with gallery module 512 could be correlated, downloaded, or otherwise prepared in a report, summary, chart, or spreadsheet form.

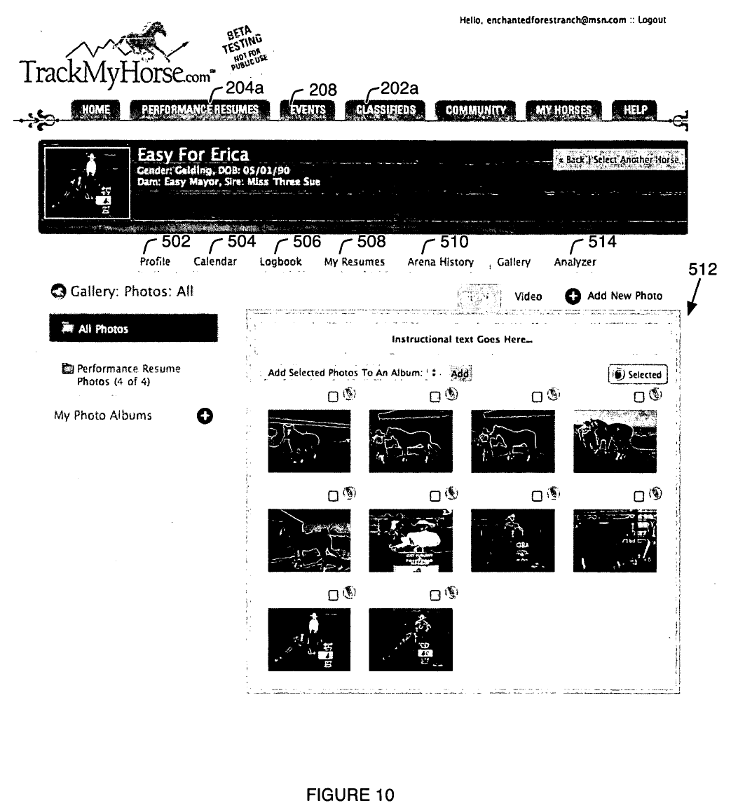

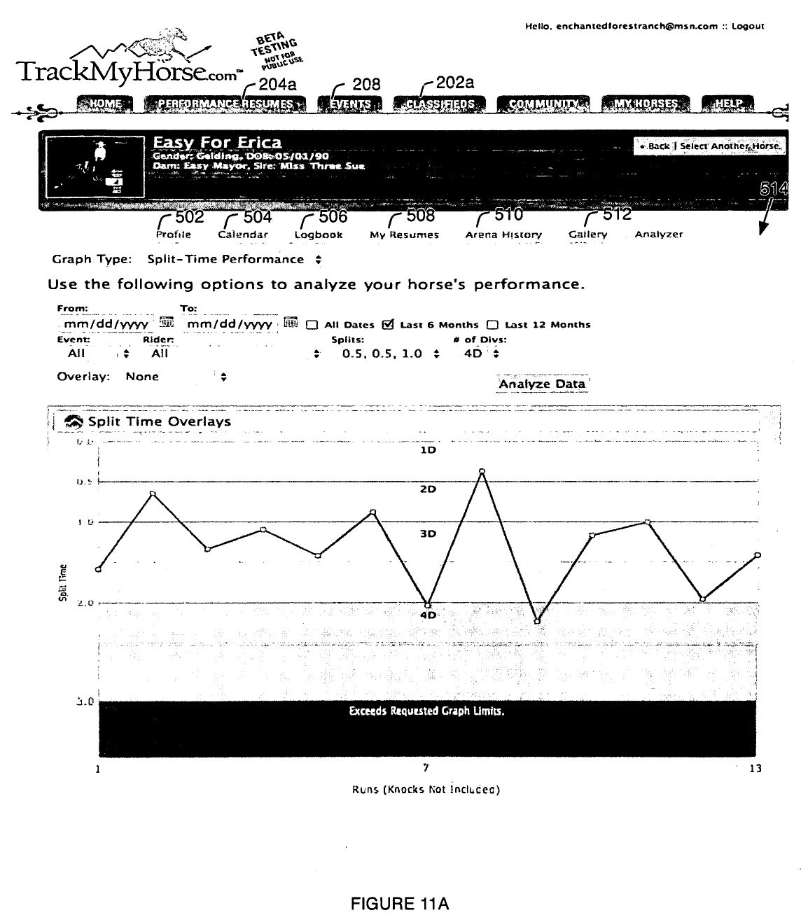

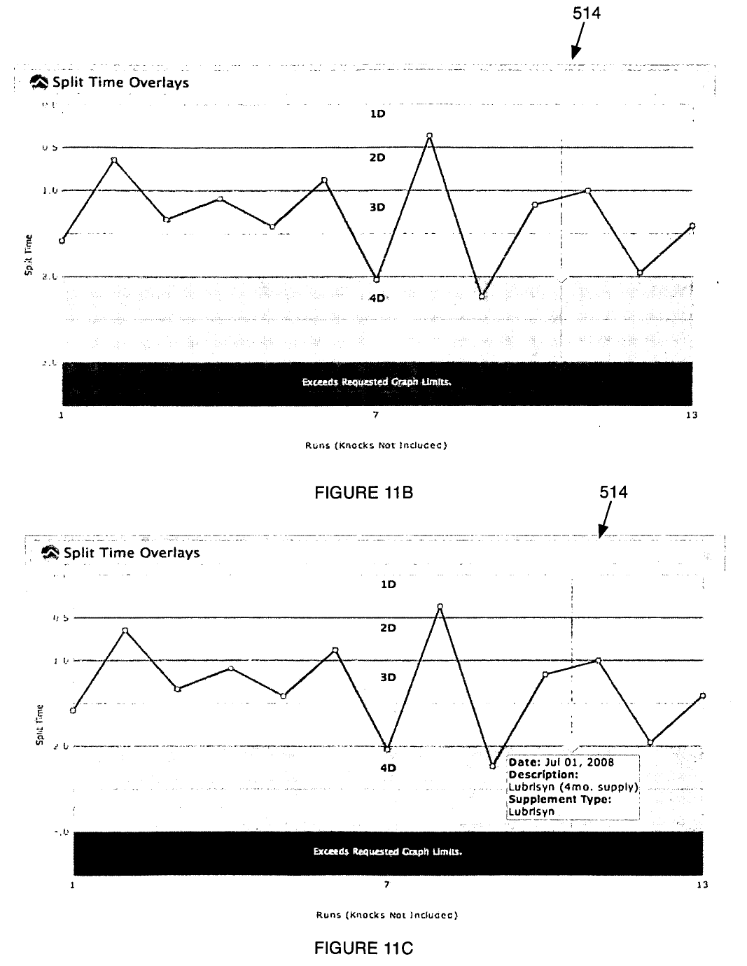

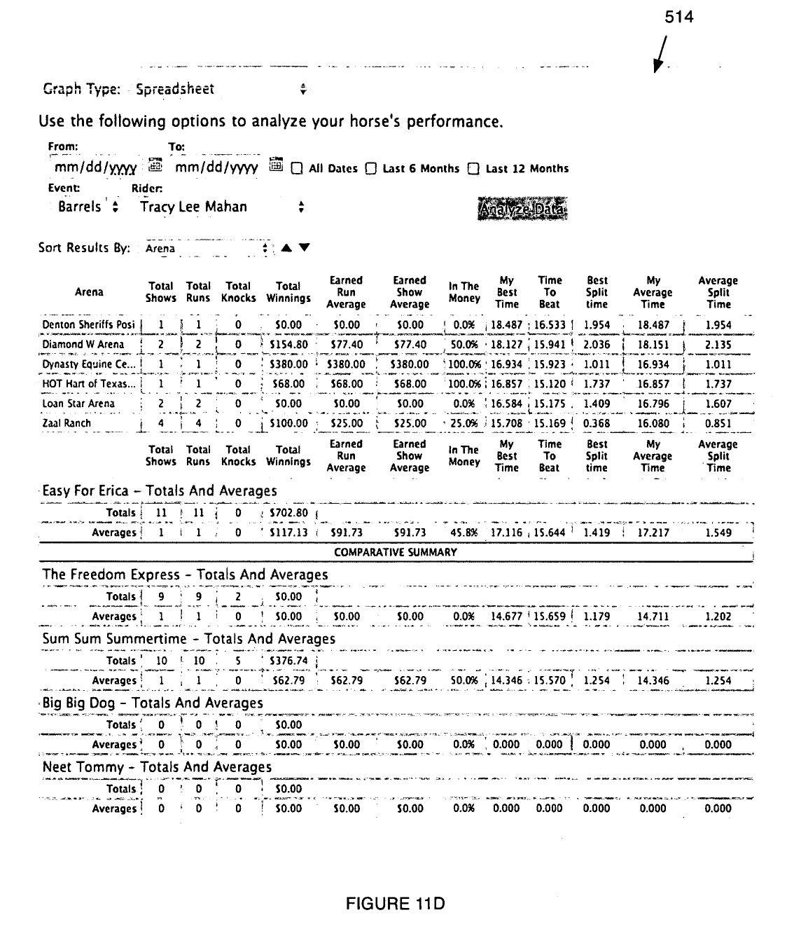

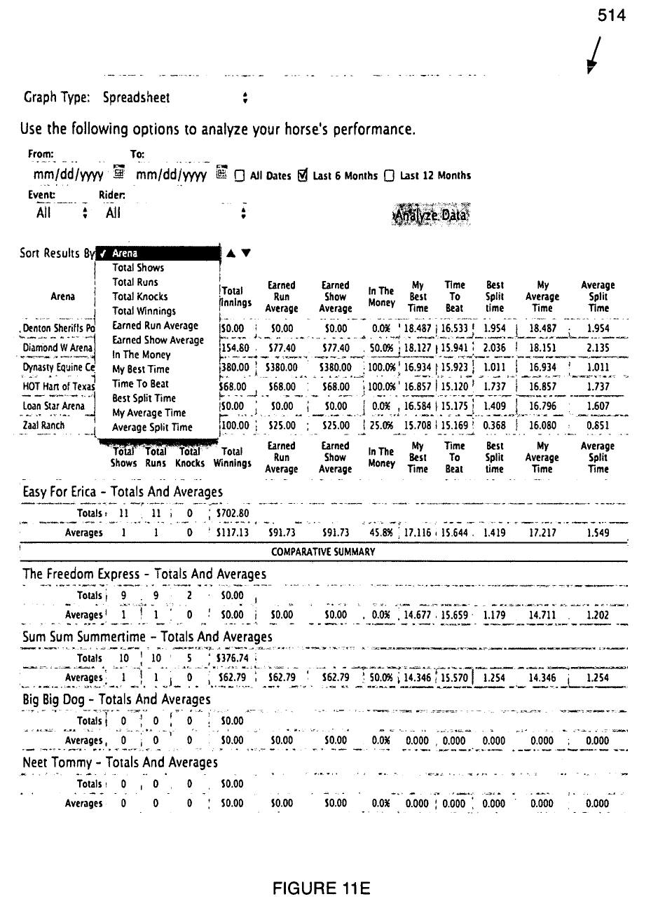

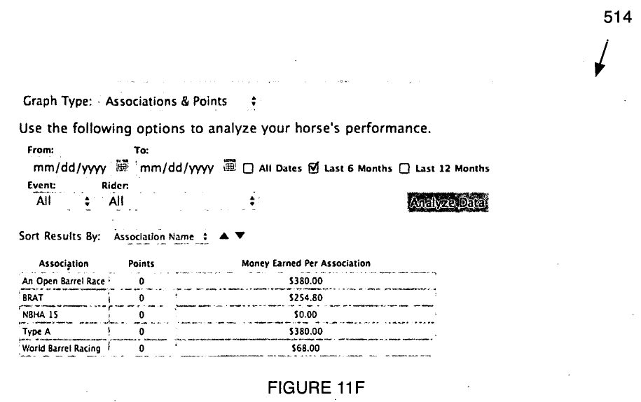

FIGS. 11A, 11B, 11C, 11D, 11E, and 11F are exemplary illustrations of a GUI associated with analyzer module 514 according to one embodiment of the present disclosure. It should be understood that analyzer module 514 shown in FIGS. 11A, 11B, 11C, 11D, 11E, and 11F are for illustrative purposes only and that any other suitable modules, GUIs, or webpages could be used in accordance with the present disclosure.

Analyzer module 514 correlates and provides a visual picture of how a particular horse is responding to various aspects of care and management including medical, supplement, and farrier related events as shown in FIGS. 11A-11F. For example, analyzer module 514 could be used to assess whether a particular vitamin supplement enhanced performance over a short time period or had a long-term effect. Information stored in or associated with analyzer module 514 could be correlated, downloaded, or otherwise prepared in a report, summary, chart, or spreadsheet form and sorted according to a number of different criteria and analyzed against data associated one or more other horses.

In one embodiment, analyzer module 514 could provide a simple and clear analysis of a horse's overall performance in a visual manner. For example, analyzer module 514 could deliver a picture of how a horse is responding to various aspects of care and management including any medical, supplement, and farrier changes or events. In one embodiment, analyzer module 514 could be configured to focus, narrow down, zoom, or expand the graphical display or performance history graph and overlay that graph with the events from the horse's profile as shown in FIG. 11B. For example, the user could select one or more categories to display on the graph from an overlay dropdown box or other list of options. In the example illustrated in FIG. 11B, such information is displayed on the graph as a vertical line overlaying the graphical chart.

In one embodiment, a “mouse-over” feature could display a pop-up window or other data relaying mechanism that provides details on both the horse's runs overlaid with the selected events as shown in FIG. 11C. Moreover, the user could use analyzer module 514 to analyze when or how their horse performs at its best. In one embodiment, for example, analyzer module 514 could display the correlated information in a spreadsheet or other tabular format that allows the user to review data associated with a selected horse's runs at one time and sort them based on specific performance criteria such as best split time, total winnings, and any run averages. Analyzer module 514 could also make a quick comparison of the data against other horses in the user's database.

Analyzer module 514 could use performance metrics in which the data could be analyzed against a key metric. For example, in one embodiment, analyzer module 514 could include a metric dubbed “split time.” The split time (St) is the time run in a particular race (tr) minus the winning time of the race (tw) (i.e., St=tr−tw). When an authorized user wants to perform an analysis, the authorized user chooses a characteristic to analyze and the system gauges that characteristic against the “split time” metric over a period of time. The user can choose to visually display the results in a variety of different methods including, for example, graphical displays, bar charts, line graphs, pie charts, data tables, spread sheets, etc.

FIG. 11D is an exemplary illustration of a GUI displaying data associated with analyzer module 514 in spreadsheet form. The results could be sorted by a number of different criteria. For example, the results could be sorted by arena, total shows, total runs, total knocks, total winnings, earned run average, earned show average, in the money, my best time, time to beat, best split time, average time, average split time, horse, number of horses, rider, dates, range of dates, events, other suitable criteria, or any combination thereof, as shown in the example illustrated in FIG. 11E. In addition, the data associated with analyzer module 514 could be displayed by association, related points, money earned per association, other suitable criteria, or combination thereof as shown in the example illustrated in FIG. 11F.

Accordingly, the authorized user can store past and current racing information and compare that information to a particular characteristic or set of characteristics to prepare reports, objective rating/performance systems, training regimens, value assessments and otherwise compare and analyze the data in real time for a variety of other reasons using analyzer module 514.

The authorized user can access, create performance reports, and/or update data on the proposed system via the web using any device configured to access the Internet including, for example, any stand alone computer, networked device or suitable mobile device. The authorized user could ultimately decide how and when a particular report is accessible by third parties.

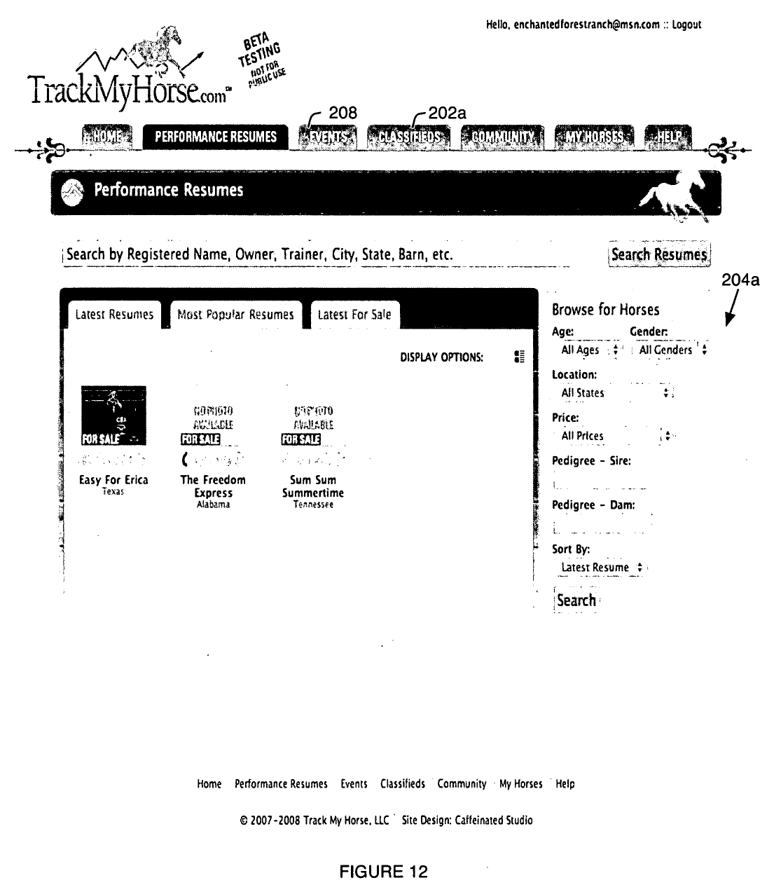

FIG. 12 is an exemplary illustration of a GUI of a webpage of the system shown in FIG. 1 displaying performance resume link 204a according to one embodiment of the present disclosure. Performance resume link 204a displays those performance resumes that are associated with resumes module 508 shown in FIGS. 8A and 8B and selected for public viewing. Additionally, in one embodiment, a member of website 108 could specify whether a particular performance resume should be made available to any member of the public, only to other members of website 108, only to specific members of website 108, or kept private. Performance resume link 204a is for illustrative purposes only and that any other suitable modules, GUIs, or webpages could be used in accordance with the present disclosure.

In the example shown in FIG. 12, there are three performance resumes illustrated and available for public viewing. It should be understood that any number of performance resumes could be included or otherwise associated with performance resume link 204a. The performance resumes could be searched by a number of different criteria including, for example, age, gender, location, price, pedigree-sire, pedigree-dam, latest resume, time of posting, other suitable categories or information related to a horse, owner, company, race type, arena, or any suitable combination thereof.

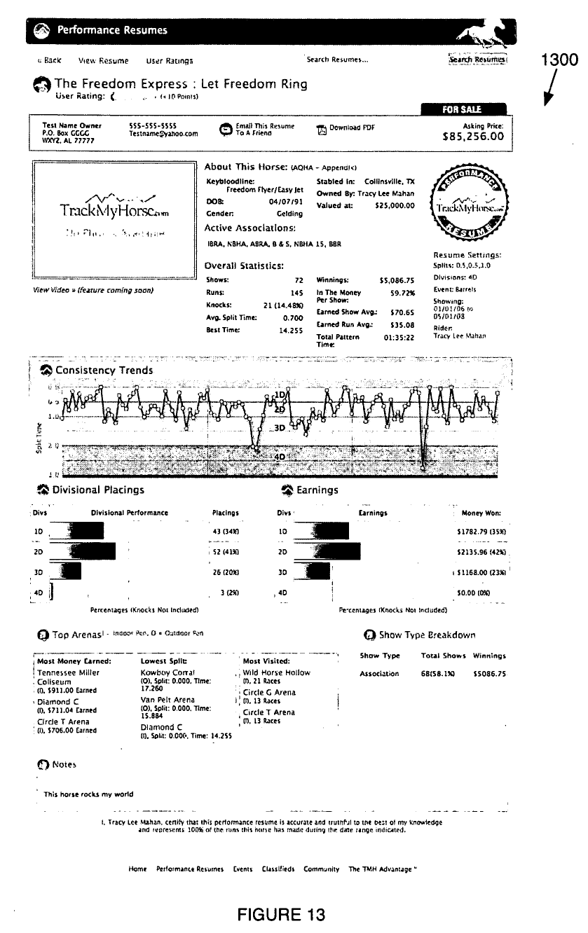

FIG. 13 is an exemplary illustration of a GUI of a webpage of the system shown in FIG. 1 displaying a selected performance resume 1300 according to one embodiment of the present disclosure. Performance resume 1300 is for illustrative purposes only and that any other suitable modules, GUIs, or webpages could be used in accordance with the present disclosure. Performance resume 1300 is generally a graphical display of information selected to be included using resumes module 508 shown in FIGS. 8A and 8B, or any other suitable system as described herein. Performance resume 1300 could include, for example, the horse's name, user rating, owner information, asking price, status of sale, bloodline information, stable information, date of birth, gender, value estimation, association or membership information, overall statistics, number of shows raced in, run statistics, knock statistics, earnings, split time, winnings, earned show average, earned run average, total pattern time, best time, consistency trends, divisional placings, top arena performances, show types, other suitable criteria, and any combination thereof.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An integrated system of managing and correlating equestrian related information, the system comprising:
a logbook to store the equestrian related information;
an analyzer to correlate the equestrian related information according to a user request; and
a graphical user interface (GUI) accessible by the Internet to display the correlated data.

2. The system of claim 1, wherein the equestrian related information comprises biological information about a horse and competitive race information related to the horse.

3. The system of claim 1, wherein the equestrian related information comprises medical information about a horse and competitive race information related to the horse.

4. The system of claim 1, wherein the equestrian related information comprises tack information about a horse and competitive race information related to the horse.

5. The system of claim 1, wherein the equestrian related information comprises nutritional information about a horse and competitive race information related to the horse.

6. The system of claim 1, wherein the equestrian related information comprises farrier related information about a horse and competitive race information related to the horse.

7. The system of claim 1, wherein the competitive race information comprises split-time (St) race information, wherein the split-time (St) race information comprises the difference between the time run in a particular race (tr) and the winning time of the race (tw).

8. The system of claim 1 further comprising:
a second GUI accessible by the Internet to display a performance resume for the horse, wherein the performance resume selectively conveys at least a portion of the equestrian related information, the competitive race information, and the correlated information.

9. The system of claim 1, wherein the equestrian related information comprises at least one of: divisional placing information, earnings information, race statistical information, and arena related information.

10. A method of managing and correlating equestrian related data, the method comprising:
storing equestrian information related to a horse in an Internet accessible logbook;
storing competitive race information related to the horse;
correlating the equestrian information and the competitive race information; and
displaying the correlated information using a graphical user interface (GUI).

11. The method of claim 10, wherein the equestrian information comprises biological information about the horse.

12. The method of claim 10, wherein the equestrian information comprises medical information about the horse.

13. The method of claim 10, wherein the equestrian information comprises tack information about the horse.

14. The method of claim 10, wherein the equestrian information comprises nutritional information about the horse.

15. The method of claim 10, wherein the equestrian information comprises farrier related information about a horse.

16. The method of claim 10, wherein the competitive race information comprises split-time (St) race information, wherein the split-time (St) race information comprises the difference between the time run in a particular race (tr) and the winning time of the race (tw).

17. The method of claim 10 further comprising:
displaying a performance resume for the horse, wherein the performance resume selectively conveys at least a portion of the equestrian information, the competitive race information, and the correlated information.

18. The method of claim 10, wherein the competitive race information comprises at least one of: divisional placing information, earnings information, race statistical information, and arena related information.

19. An integrated system of managing and correlating equestrian related data over the Internet, the system comprising:
a logbook to store competitive race information and the equestrian related data, the equestrian related data comprising at least one of: biological information, medical information, farrier information, tack information, nutritional information, and genealogical information;
an analyzer to correlate the competitive race information with the equestrian related data; and
a graphical user interface (GUI) accessible by the Internet to display the correlated data.

20. The system of claim 19, wherein the competitive race information comprises at least one of: split-time race information, divisional placing information, earnings information, race statistical information, and arena related information.
